(19) United States
(12) Patent Application Publication
(10) Pub. No.: US 2007/0273888 A1
(43) Pub. Date: Nov. 29, 2007

(54) Variable spectroscopy device, spectroscopy apparatus, and endoscope system

(75) Inventor: Yasuhiro Kamihara, Tokyo (JP)

Correspondence Address: Thomas Spinelli;Scully, Scott, Murphy & Presser, 400 Garden City Plaza, Garden City, NY, 11530, US

(73) Assignee: Olympus Corporation, Tokyo (JP)

(21) Appl. No.: 11/804,828

(22) Filed: May 21, 2007

(30) Foreign Application Priority Data
May 29, 2006 (JP) 2006-148041

(51) Int. Cl. G01B 9/02; G01J 3/45

(52) U.S. Cl. 356/454

(57) ABSTRACT

It is possible to a variable spectroscopy device that has a plurality of coating layers facing each other at an interval and changes a transmission band of light passing through the coating layers by adjusting an optical path length between the coating layers, in which the coating layer is structured so that a change rate of a transmission bandwidth between two arbitrary transmission bands is smaller than a change rate of a central wavelength between the two transmission bands within a spectroscopy wavelength band for changing a transmission band.

### BACKGROUND OF THE INVENTION

1. Field of the Invention

The present invention relates to a variable spectroscopy device, a spectroscopy apparatus, and an endoscope system.

This application is based on Japanese Patent Application No. 2006-148041, the content of which is incorporated herein by reference.

2. Description of Related Art

An image pickup apparatus is well-known, having an etalon spectroscopy device that varies a light transmission band by changing a surface interval between a plurality of substrates (e.g., refer to the specification of the Publication of Japanese Patent No. 2771785).

The image pickup apparatus changes the light transmission band emitted from an observation target by the etalon spectroscopy device, and obtains spectroscopy information on the observation target. Further, two different transmission characteristics are realized by changing the surface interval between two substrates having coating layers, and the difference in intensity distributions of images is calculated, thereby analyzing spectrum.

However, with respect to the image pickup apparatus disclosed in the specification of the Publication of Japanese Patent No. 2771785, a transmission bandwidth of the etalon spectroscopy device is not considered. For example, with the coating layer having uniform transmission characteristics of wavelengths, the transmission bandwidth that varies by changing the surface interval between the substrates has characteristics that the transmission bandwidth increases in proportional to the wavelength of the transmission band.

Therefore, images obtained at different transmission bands have different bandwidths of the spectroscopy information of the images. That is, an image with a narrow wavelength width is obtained on the short wavelength side, and an image (image with low wavelength-resolution) with a wide wavelength width is obtained on the long wavelength side. Further, even if a an observation target has a certain strength in spectroscopic way, the transmission bandwidth of the spectroscopy device is different and there is consequently a problem that the image on the long wavelength side is brighter than the image on the short wavelength side. Therefore, there is an inconvenience that it is not possible to easily perform quantitative comparison and calculation of a plurality of images having different transmission bands.

### BRIEF SUMMARY OF THE INVENTION

The present invention provides the following solutions.

According to the first aspect of the present invention, a variable spectroscopy device has a plurality of coating layers facing each other at an interval and changes a transmission band of light passing through the coating layers by adjusting an optical path length between the coating layers. In the variable spectroscopy device, the coating layer is structured so that a change rate of a transmission bandwidth between two arbitrary transmission bands is smaller than a change rate of a central wavelength between the two transmission bands within a spectroscopy wavelength band for changing a transmission band.

According to the first aspect of the present invention, preferably, the transmission bandwidth is constant within the spectroscopy wavelength band, irrespective of the wavelength.

Further, according to the first aspect, the transmission bandwidth may have a full width at half maximum.

Furthermore, according to the first aspect, preferably, the characteristics of the coating layer may be uniform within a plane.

In addition, according to the first aspect, the reflectance of the coating layer may monotonically increase in accordance with the increase in wavelength.

In addition, according to the first aspect, the coating layers may be arranged to facing surfaces of two optical members arranged at an interval.

In addition, according to the first aspect, the optical path length between the facing surfaces may change in the directions along the facing surfaces.

With this structure, at least one of the facing surfaces may be stepwise formed with one or more steps.

Further, with this structure, the interval between the facing surfaces may gradually change in the directions along the facing surfaces.

According to the first aspect, preferably, characteristics of the reflectance to the wavelength of the coating layer are expressed by the following relational expression

$$R ( λ ) = \frac{( β ( λ ) + 2 ) - \sqrt{{\{ β ( λ ) \}}^{2} + 4 β ( λ )}}{2}$$

$$β ( λ ) = {( \frac{π m \cdot FWHM}{λ} )}^{2}$$

where R(λ): reflectance of one etalon-type coating surface

m: degree

n: index of refraction of a medium between the etalon-type coating surfaces

FWHM: full width at half maximum as target.

With this structure, the coating layer may comprise a dielectric material.

According to the second aspect of the present invention, a spectroscopy apparatus comprises any of the variable spectroscopy devices.

Further, according to the second aspect, the spectroscopy apparatus may further comprise a two-dimensional image pickup device that shoots light passing through the variable spectroscopy device.

With this structure, an observation target may be a living body, or a part of the body cavity.

Further, according to the second aspect, the interval between the coating layers of the variable spectroscopy device may correspond to an interval having only one transmission band within the spectroscopy wavelength band.

According to the third aspect of the present invention, a spectroscopy endoscope system comprises any of the variable spectroscopy devices.

### BRIEF DESCRIPTION OF THE SEVERAL VIEWS OF THE DRAWINGS

FIG. 1 is a longitudinal cross-sectional view showing a variable spectroscopy device according to the first embodiment of the present invention.

FIG. 2 is a graph showing characteristics of the reflectance of a reflection film of the variable spectroscopy device shown in FIG. 1.

FIG. 3 is a block diagram showing the entire structure of an endoscope system according to the first embodiment of the present invention.

FIG. 4 is a schematic diagram showing the inner structure of an image pickup unit in the endoscope system shown in FIG. 3.

FIG. 5 is a graph showing characteristics of the transmittance of a variable spectroscopy device structuring the endoscope system shown in FIG. 3.

FIG. 6 is a graph showing characteristics of the reflectance of a reflection film according to one modification of the variable spectroscopy device shown in FIG. 1.

FIG. 7 is a graph showing characteristics of the reflectance of a reflection film according to another modification of the variable spectroscopy device shown in FIG. 1.

FIG. 8 is a block diagram showing the entire structure of an endoscope system according to the second embodiment of the present invention.

FIG. 9 is a schematic diagram showing the inner structure of an image pickup unit in the endoscope system shown in FIG. 8.

FIG. 10 is a graph showing characteristics of the transmittance of a variable spectroscopy device structuring the endoscope system shown in FIG. 8.

FIG. 11 is a graph showing characteristics of the reflectance of a reflection film of the variable spectroscopy device shown in FIG. 10.

FIG. 12 is a diagram showing characteristics of optical parts forming the endoscope system shown in FIG. 8, and characteristics of the transmittance, and wavelength characteristics of excitation light and illumination light.

FIG. 13 is a timing chart for illustrating the operation of the endoscope system shown in FIG. 8.

FIG. 14 is a schematic diagram showing the inner structure of an image pick-up unit having a variable spectroscopy device shown in FIG. 10 according to one modification.

FIG. 15 is a schematic diagram showing the inner structure of an image pick-up unit having a variable spectroscopy device shown in FIG. 10 according to another modification.

### DETAILED DESCRIPTION OF THE INVENTION

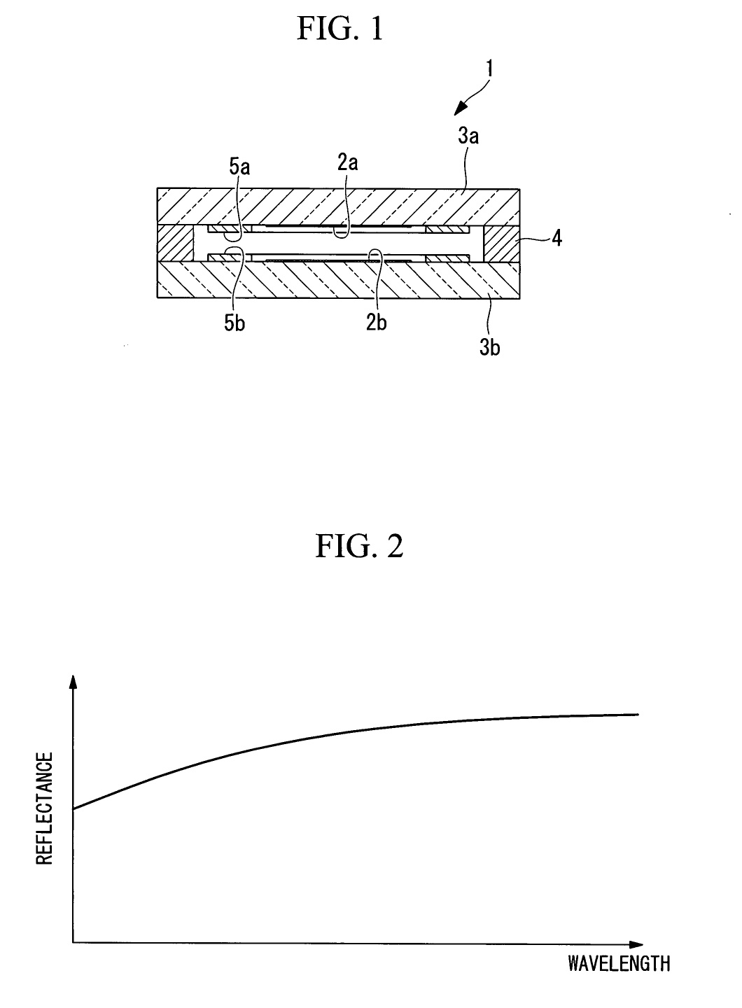

Hereinbelow, a variable spectroscopy device 1 and an endoscope system (spectroscopy apparatus) 10 having the variable spectroscopy device 1 will be described according to the first embodiment of the present invention with reference to FIGS. 1 to 5.

Referring to FIG. 1, the variable spectroscopy device 1 according to the first embodiment is an etalon-type optical filter comprising two planar optical members 3a and 3b having reflection films (coating layers) 2a and 2b arranged with a parallel interval within an optical effective diameter of facing surfaces thereof, and an actuator 4 that changes the interval between the optical members 3a and 3b.

The actuator 4 is a cylindrical member comprising a piezoelectric element, and changes the length dimension in accordance with a drive signal.

The variable spectroscopy device 1 changes the interval dimension between the optical members 3a and 3b by the operation of the actuator 4, thereby changing the wavelength band of the transmission light.

The interval dimension between the optical members 3a and 3b is set to have a minute value, e.g., a value on micron order or less.

Further, ring-shaped capacitance sensor electrodes 5a and 5b are arranged to the outside of the optical effective diameter.

The reflection films 2a and 2b comprise, e.g., dielectric multi-layers.

Further, the capacitance sensor electrodes 5a and 5b comprise metallic films. Signals from the capacitance sensor electrodes 5a and 5b are fed-back to control a drive signal to a drive unit, thereby improving the adjusting precision of transmission characteristics.

Specifically, the variable spectroscopy device 1 according to the first embodiment has reflectance characteristics as shown in FIG. 2. The reflectance characteristics satisfy the following relational expression (1)

$$R ( λ ) = \frac{( β ( λ ) + 2 ) - \sqrt{{\{ β ( λ ) \}}^{2} + 4 β ( λ )}}{2} \\ β ( λ ) = {( \frac{π m \cdot FWHM}{λ} )}^{2} \qquad ( 1 )$$

where R(λ): reflectance of one etalon-type coating surface

m: degree

n: index of refraction of a medium between the etalon-type coating surfaces

FWHM: full width at half maximum as target.

Herein, the derivation of Expression (1) will be described.

Reference numeral R(λ) denotes the reflectance of one surface of the reflection films 2a and 2b, reference numeral θ denotes an incident angle of light, reference numeral n denotes a refraction of a medium between the reflection films 2a and 2b, and reference numeral d denotes an interval between the reflection films 2a and 2b. Then, a transmittance T is expressed by the following Expression (2).

$$T = \frac{1}{1 + \frac{4 R}{{( 1 - R )}^{2}} {sin}^{2} ( \frac{2 π nd}{λ} cos θ )} \qquad ( 2 )$$

Herein, the full width at half maximum FWHM is expressed by the following Expression (3).

$$FWHM = \frac{{λ}^{2}}{2 nd} \cdot \frac{1 - R}{π \sqrt{R}} \qquad ( 3 )$$

Herein, an optical path length is changed with a relation of the following Expression (4)

nd=m λ/2 (4)

where m: integer not less than 1. Then, at a wavelength λ, the transmittance has a maximum value with vertical incidence. This relation is substituted into Expression (3), and the solution of a quadratic equation obtained with respect to the reflectance R(λ) is obtained, thereby obtaining Expression (1).

Further, with Expression (1), the full width at half maximum FWHM is constant, thereby obtaining the reflectance characteristics shown in FIG. 2.

The phase shift Ø by the etalon-type coating is ignored in the above description. More precise characteristics can be obtained by using the following Expression (5) which takes the phase shift Ø into consideration, instead of Expression (4).

nd=(m−φ/π)λ/2 (5)

With the variable spectroscopy device 1 having the above-mentioned structure according to the first embodiment, the interval dimension between the optical members 3a and 3b is changed, thereby changing the transmission band of the light. Even in this case, the full width at half maximum FWHM is constant, thereby suppressing the reduction of a wavelength resolution on the long-wavelength side. Further, the change in amount of transmission light depending on the wavelength can be prevented.

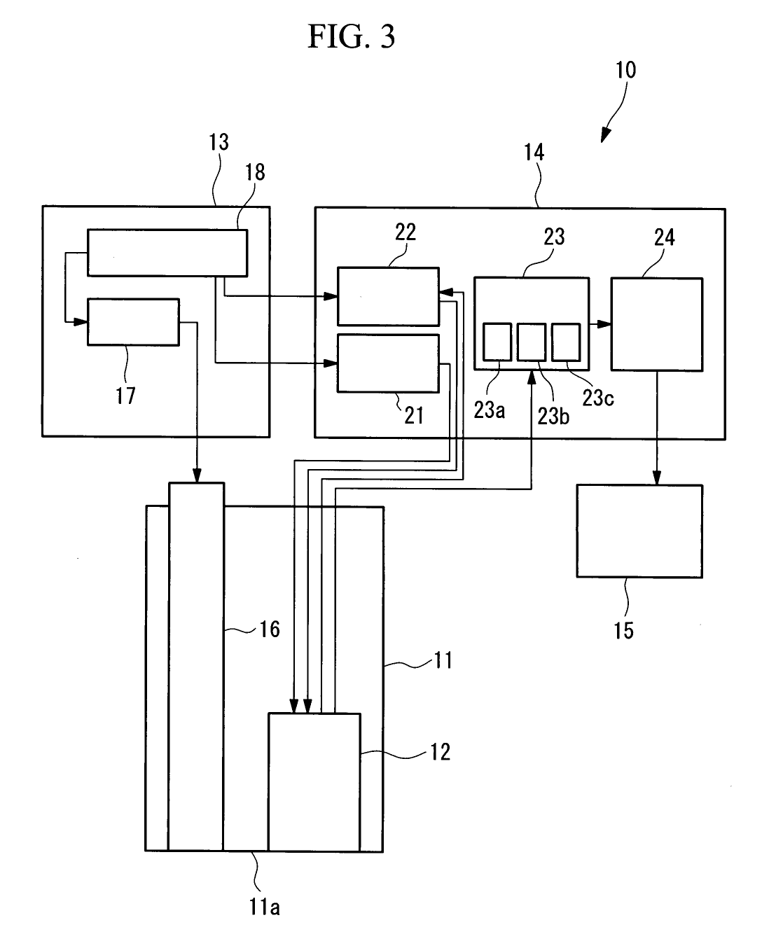

Next, a description will be given of the endoscope system 10 using the variable spectroscopy device 1 according to the first embodiment with reference to FIGS. 3 to 5.

Referring to FIG. 3, the endoscope system 10 according to the first embodiment comprises: an inserting unit 11 that is inserted in the in-vivo body cavity; an image pickup unit 12 arranged in the inserting unit 11; a light source unit 13 that emits illumination light; a control unit 14 that controls the image pickup unit 12 and the light source unit 13; and a display unit 15 that displays the image obtained by the image pickup unit 12.

The inserting unit 11 has an extremely thin outer-dimension for insertion to the in-vivo body cavity, and comprises the image pickup unit 12 and a light guide 16 that propagates light from the light source unit 13 to an end 11a.

The light source unit 13 illuminates a observation target in the body cavity, and comprises a light source 17 for illumination light that emits illumination light for obtaining reflection light that is reflected and returned from the observation target, and a light source control circuit 18 that controls the light source 17 for illumination light.

The light source 17 for illumination light is formed by combining a xenon-arc lamp and a band-pass filter (which are not shown), and a transmission band of 50% of the band-pass filter ranges 430 to 700 nm. That is, the light source 17 for illumination light generates the illumination light having the wavelength band ranging 430 to 700 nm.

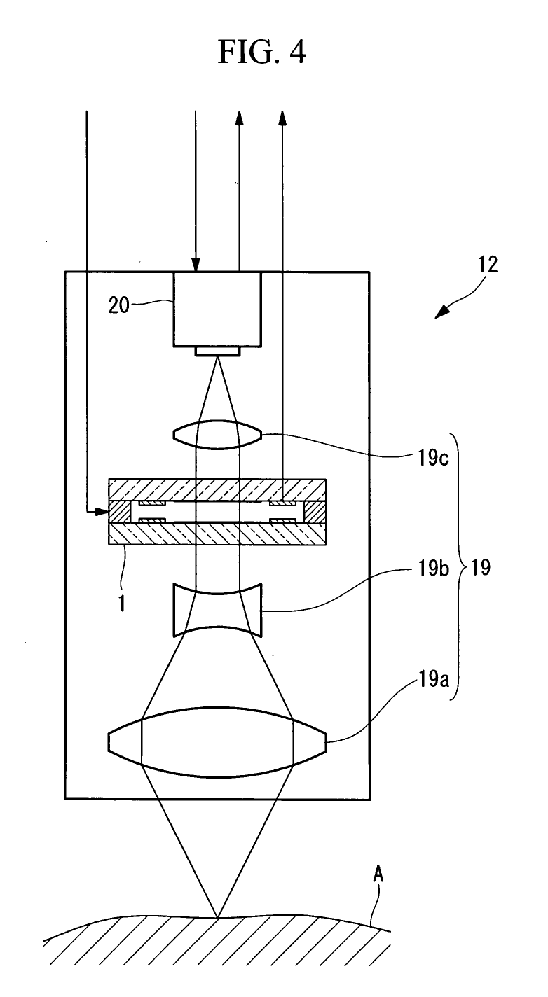

Referring to FIG. 4, the image pickup unit 12 comprises an image pickup optical system 19, having three lenses 19a, 19b, and 19c, for condensing incident light from a observation target A, the variable spectroscopy device 1 according to the first embodiment that changes spectral characteristics by the operation of the control unit 14, and an image pickup element 20 that captures the light condensed by the image pickup optical system 19 and converts the light into an electrical signal.

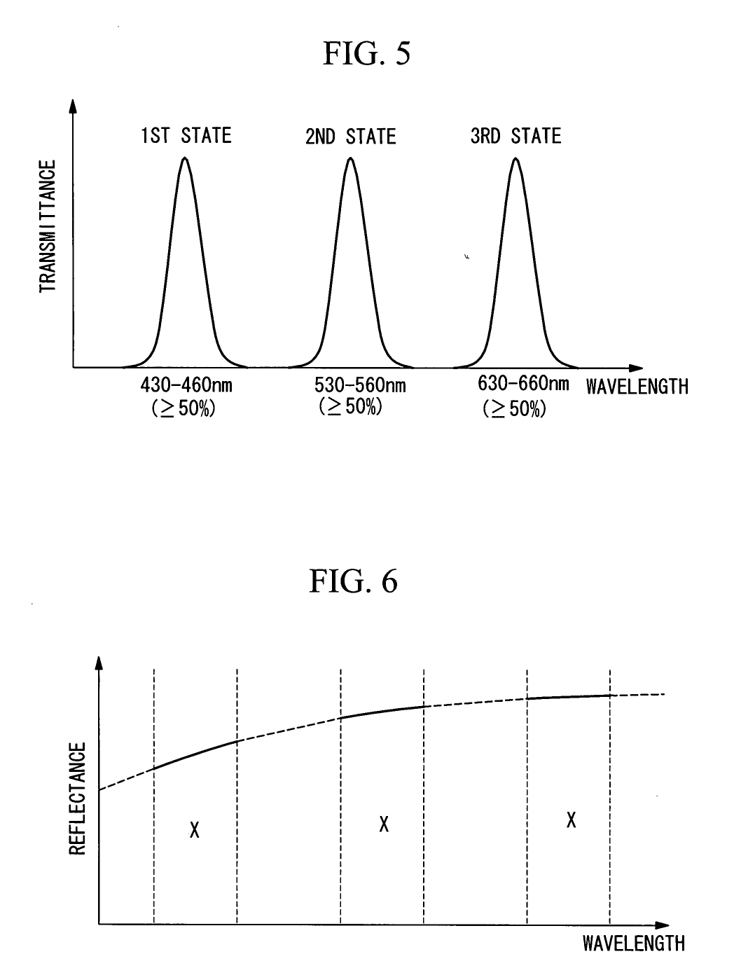

According to the first embodiment, referring to FIG. 5, a variable-wavelength band of the variable spectroscopy device 1 is changed into three states in accordance with control signals from the control unit 14.

In the first state, light having a band of wavelengths b 430 to 460 nm, serving as a blue region of visible light, is transmitted. Hereinafter, the transmission bandwidth is defined as the full width at half maximum FWHM of the peak intensity.

In the second state, light having a band of wavelengths 530 to 560 nm, serving as a green region of visible light, is transmitted.

In the third state, light having a band of wavelengths 630 to 660 nm, serving as a green region of visible light, is transmitted.

Referring to FIG. 3, the control unit 14 comprises: an image pickup device control circuit 21 that controls the driving of the image pickup element 20; a variable spectroscopy device control circuit 22 that controls the driving of the variable spectroscopy device 1; a frame memory 23 that stores image information obtained by the image pickup element 20; and an image processing circuit 24 that processes the image information stored in the frame memory 23 and outputs the processed information to the display unit 15.

When the variable spectroscopy device control circuit 22 sets the variable spectroscopy device 1 to the first state, the image pickup device control circuit 21 outputs the image information output from the image pickup element 20 to a first frame memory 23a. Further, when the variable spectroscopy device control circuit 22 sets the variable spectroscopy device 1 to the second state, the image pickup device control circuit 21 outputs the image information output from the image pickup element 20 to a second frame memory 23b. Furthermore, when the variable spectroscopy device control circuit 22 sets the variable spectroscopy device 1 to the third state, the image pickup device control circuit 21 outputs the image information output from the image pickup element 20 to a third frame memory 23c.

The image processing circuit 24 receives the image information on the blue band from the first frame memory 23a, and outputs the received information to a first channel of the display unit 15. Further, the image processing circuit 24 receives the image information on the green band from the second frame memory 23b, and outputs the received information to a second channel of the display unit 15. Furthermore, the image processing circuit 24 receives the image information on the red band from the third frame memory 23c, and outputs the received information to a third channel of the display unit 15.

Hereinbelow, a description will be given of the operation of the endoscope system 10 with the above-mentioned structure according to the first embodiment.

In order to capture an image of the observation target A in the in-vivo body cavity with the endoscope system 10 according to the first embodiment, the inserting unit 11 is inserted into the body cavity, and the end 11a faces the observation target A in the body cavity. In this state, the light source unit 13 and the control unit 14 are operated, and the operation of the light source control circuit 18 operates the light source 17 for illumination light, thereby generating the illumination light.

The illumination light generated by the light source unit 13 is propagated via the light guide 16 to the end 11a of the inserting unit 11, and irradiated from the end 11a of the inserting unit 11 to the observation target A.

The illumination light is reflected to the surface of the observation target A, the reflection light is condensed by the image pickup optical system 19 and is transmitted to the variable spectroscopy device 1, the image is formed on the image pickup element 20, and the image information on the reflection light is obtained.

In order to obtain the reflection light image of the blue band, the operation of the variable spectroscopy device control circuit 22 switches the variable spectroscopy device 1 to the first state, thereby limiting the band of the reflection light reaching the image pickup element 20 to wavelengths 430 to 460 nm. Further, the obtained reflection light image of the blue band is stored to the first frame memory 23a, and is output to the first channel of the display unit 15.

In order to obtain the reflection light image of the green band, the operation of the variable spectroscopy device control circuit 22 switches the variable spectroscopy device 1 to the second state, thereby limiting the band of the reflection light reaching the image pickup element 20 to wavelength 530 to 560 nm. Further, the obtained reflection light image of the green band is stored to the second frame memory 23b, and is output to the second channel of the display unit 15.

In order to obtain the reflection light image of the red band, the operation of the variable spectroscopy device control circuit 22 switches the variable spectroscopy device 1 to the third state, thereby limiting the band of the reflection light reaching the image pickup element 20 to wavelength 630 to 660 nm. Further, the obtained reflection light image of the red band is stored to the third frame memory 23c, and is output to the third channel of the display unit 15.

As mentioned above, with the endoscope system 10 according to the first embodiment, the reflection light from the observation target A is spectroscopically displayed every wavelength band.

Effectively, the in-vivo image information using various wavelengths is obtained. With the endoscope system 10 according to the first embodiment, the transmission bandwidth of the variable spectroscopy device 1 can be constant throughout a wide wavelength band. Therefore, it is possible to prevent the occurrence of an inconvenience that the wavelength resolution of the image information on the reflection light of the wavelength band on the long wavelength side is lower than the image information on the reflection light of another wavelength band and the intensity of the reflection light of the wavelength band on the long wavelength side is higher than the image information on the reflection light of another wavelength band.

As a consequence, advantageously, it is possible to perform the display operation with superimposing using the image information on the reflection light of a plurality of wavelength bands and easily perform calculation between the images without complicated correction processing.

Incidentally, the variable spectroscopy device 1 and the endoscope system 10 according to the first embodiment can be modified and be changed as follows.

First, the variable spectroscopy device 1 according to the first embodiment has characteristics of the reflectance shown in FIG. 2 throughout the entire band of the spectroscopy wavelength, as mentioned above. In place of this, referring to FIG. 6, only at a wavelength band X for obtaining the spectroscopy information, the variable spectroscopy device 1 may have characteristics of the reflectance based on Expression (1). As a consequence, the limiting condition about the design and manufacturing of the reflection films 2a and 2b is released and, advantageously, the design and manufacturing can be easy.

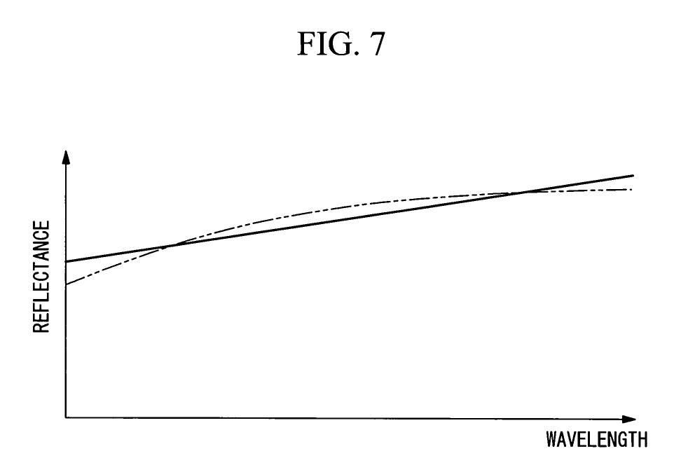

Further, in place of this, referring to FIG. 7, the reflection films 2a and 2b having characteristics of the reflectance based on a linear function approximate to the characteristics of the reflectance based on Expression (1) may be used. As the linear function in this case, a linear function having a positive proportional coefficient more than 0 monotonically increasing can be used. As a consequence, the change in transmission bandwidth depending on the wavelength of the transmission band can be suppressed.

Further, according to the first embodiment, the full width at half maximum FWHM indicating the amount of the transmission bandwidth is used. Further, the amount excluding the full width at half maximum FWHM may be used as an index.

Further, with the variable spectroscopy device 1 according to the first embodiment, the interval dimension between the two optical members 3a and 3b is changed by the actuator 4 comprising the piezoelectric element as an example. In place of this, the interval dimension may be changed by another actuator. Further, the index of refraction of a medium (e.g., liquid or gas) filled in a gap between the optical members 3a and 3b is changed, thereby changing the length of the optical path while maintaining the interval.

Further, as the endoscope system 10, a flexible scope and a rigid scope may be used. Alternatively, as the endoscope system 10, an objective lens for in-vivo observation may be used, instead of an endoscope. According to the first embodiment, the transmission bandwidth can be constant by the single variable spectroscopy device 1 irrespective of the wavelength band without using the method for insertion and detachment to/from optical paths of a plurality of optical filters. Therefore, the endoscope system 10 is particularly suitable to an in-vivo observing system such as an endoscope with a restriction of the dimension of a diameter direction.

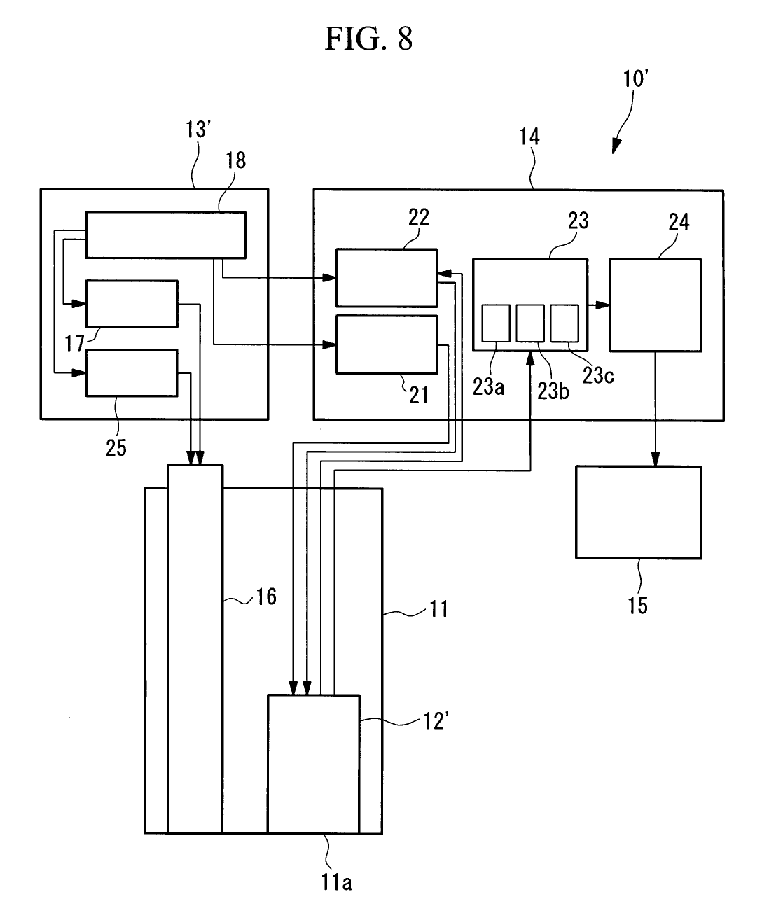

Hereinbelow, a description will be given of an endoscope system 10′ according to the second embodiment of the present invention with reference to FIGS. 8 to 13.

In the following description according to the second embodiment, portions common to the structure of the endoscope system 10 according to the first embodiment are designated by the same reference numerals, and are not described.

In the endoscope system 10′ according to the second embodiment, a light source unit 13′ comprises a light source 25 for excitation light in addition to the light source 17 for illumination light.

The light source 17 for illumination light is formed by combining a xenon lamp and a band-pass filter (which are not shown), and the band-pass filter has a transmission band of 50% corresponding to 430 to 460 nm.

Further, the light source 25 for excitation light is a semiconductor laser that emits excitation light having a peak wavelength of, e.g., 660±5 nm. The excitation light having the wavelengths can excite a fluorescent agent such as Cy5.5 and Cy7 (registered trademarks of GE Healthcare, Inc. (formerly Amersham Biosciences Corp.)) or Alexa Fluor (registered trademark) 700 (of Molecular Probes, Inc.).

Among those, the description according to the second embodiment uses two types of fluorescent agents including Cy5.5 (peak wavelength 694 nm and fluorescent wavelength range 670 to 710 nm) and Cy7 (peak wavelength 767 nm and fluorescent wavelength range 760 to 800 nm).

The light source control circuit 18 alternately lights-on and lights-off the light source 17 for illumination light and the light source 25 for excitation light at a predetermined timing based on a timing chart, which will be described later.

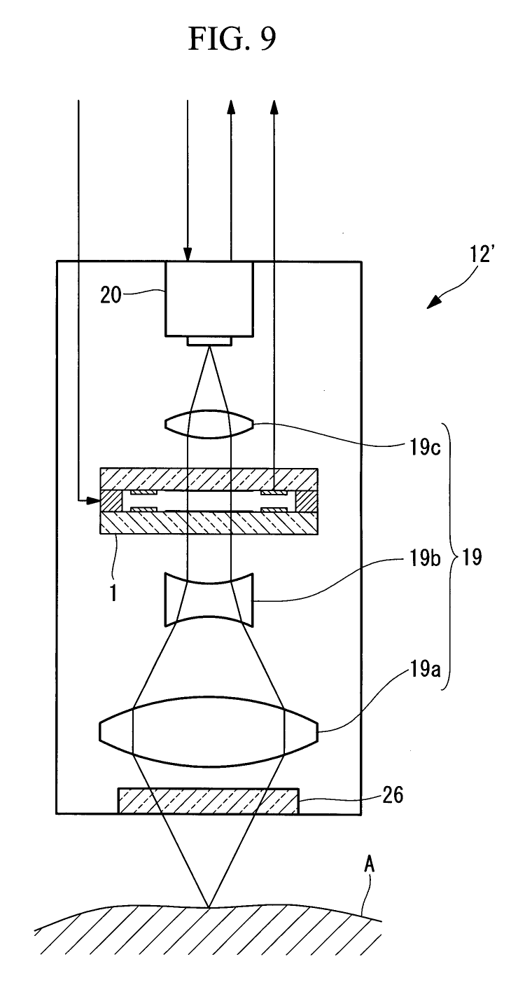

Referring to FIG. 9, an image pickup unit 12′ further comprises an excitation light cut-off filter 26 that cuts-off excitation light incident from the observation target A.

The excitation light cut-off filter 26 has characteristics of the transmittance including, e.g., the transmittance of 80% or more at wavelengths 420 to 640 nm, an OD value of 4 or more (=the transmittance 1×10⁻⁴ or less) at wavelengths 650 to 670 nm, and the transmittance of 80% or more at wavelengths 690 to 750 nm.

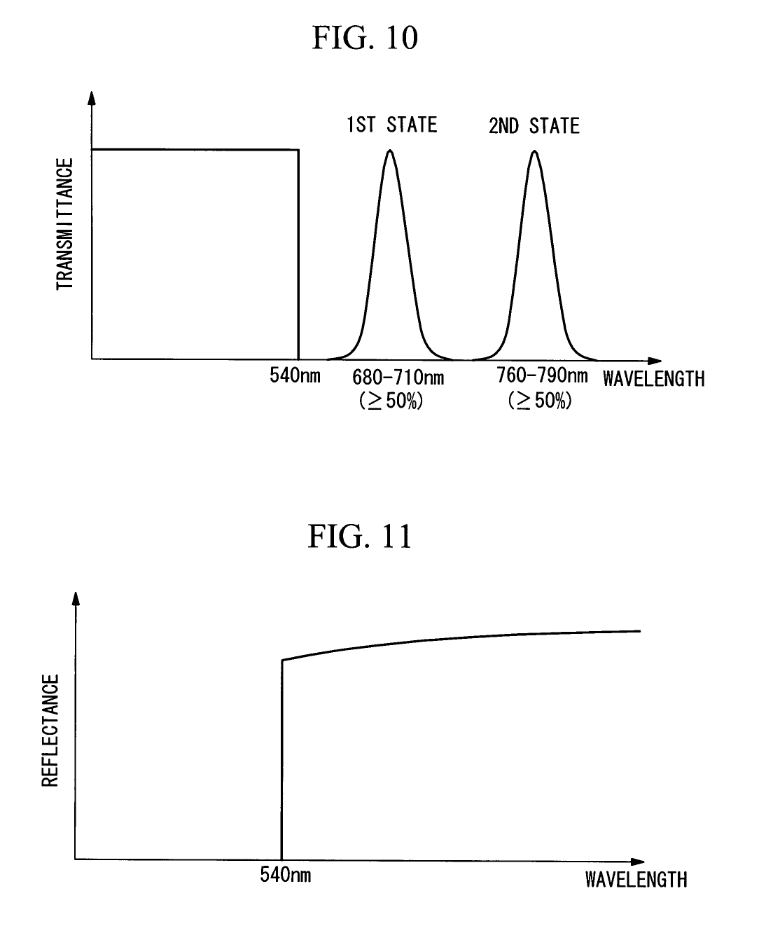

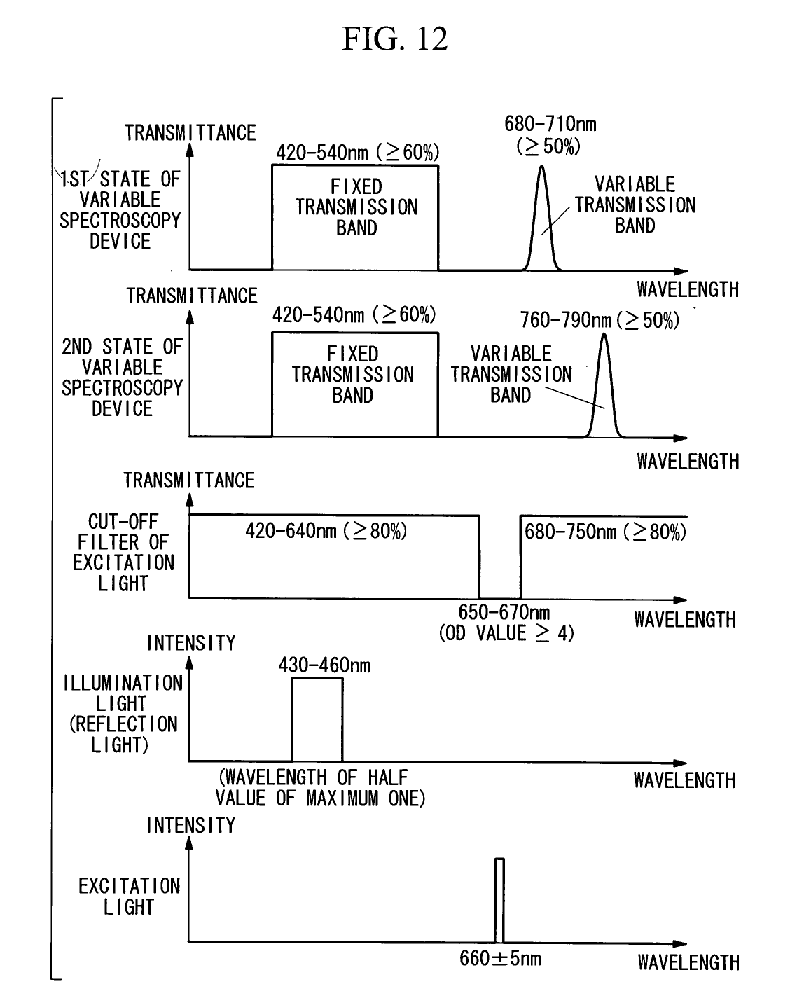

Referring to FIGS. 10 and 12, the variable spectroscopy device 1 has a fixed transmission band and a variable transmission band. At the fixed transmission band, the light is always transmitted independently of the state of the variable spectroscopy device 1. For example, the variable spectroscopy device 1 is arranged within the range of wavelengths 420 to 540 nm, and is designed with the average transmittance of 60% or more. Further, the variable transmission band changes the characteristics of the transmittance in accordance with the state of the variable spectroscopy device 1. In order to structure the variable spectroscopy device 1, referring to FIG. 11, the reflection films 2a and 2b has characteristics of the reflectance of 40% or less at the fixed transmission band, and characteristics of the reflectance based on Expression (1) described according to the first embodiment at the variable transmission band.

According to the second embodiment, the variable spectroscopy device 1 has a variable transmission band at wavelength bands (e.g., 680 to 710 nm and 760 to 790 nm) including fluorescent wavelengths (due to a fluorescent agent) generated by exciting a fluorescent agent with excitation light. Further, the variable spectroscopy device 1 is controlled in accordance with the control signal from the control unit 14 to two states having a first state for setting the variable transmission band to a wavelength band 680 to 710 nm and a second state for setting the variable transmission band to a wavelength band 760 to 790 nm.

The image pickup device control circuit 21 and the variable spectroscopy device control circuit 22 are connected to the light source control circuit 18, and controls the driving of the variable spectroscopy device 1 and the image pickup element 20 synchronously with the switching of the light source 17 for illumination light and the light source 25 for excitation light by the use of the light source control circuit 18.

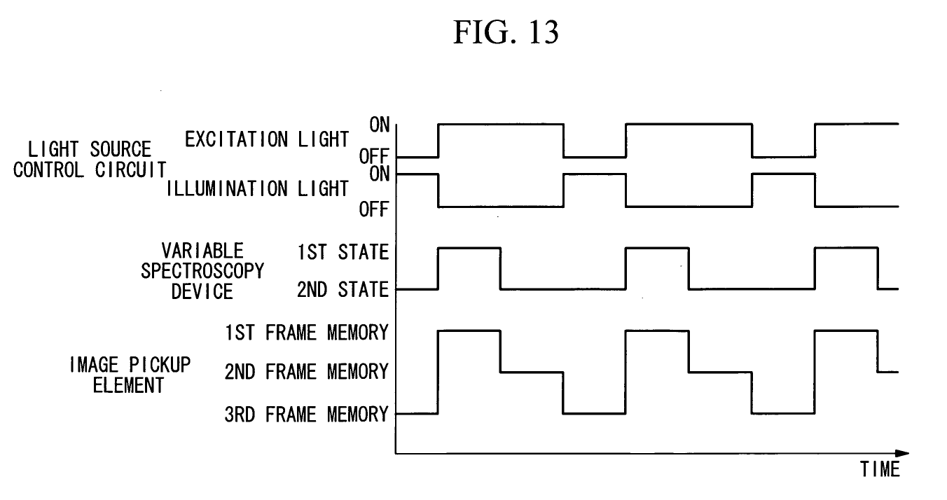

More specifically, as shown in a timing chart shown in FIG. 13, when the light source 25 for excitation light emits the excitation light by the operation of the light source control circuit 18, the variable spectroscopy device control circuit 22 controls the variable spectroscopy device 1 to be in the first state, and the image pickup device control circuit 21 outputs image information output from the image pickup element 20 to the first frame memory 23a.

Further, after the passage of a predetermined time from the time for emitting the excitation light from the light source 25 for excitation light, the variable spectroscopy device control circuit 22 controls the variable spectroscopy device 1 to be in the second state by the operation of the variable spectroscopy device control circuit 22, and the image pickup device control circuit 21 outputs image information output from the image pickup element 20 to the second frame memory 23b.

Further, when the light source 17 for illumination light emits illumination light by the operation of the light source control circuit 18, the variable spectroscopy device control circuit 22 keeps the variable spectroscopy device 1 to be in the second state, the image pickup device control circuit 21 outputs image information output from the image pickup element 20 to the third frame memory 23c.

Further, the image processing circuit 24 receives the fluorescent image information on Cy5.5 obtained by the emission of the excitation light from the first frame memory 23a, and outputs the received fluorescent image information to a first channel of the display unit 15. Furthermore, the image processing circuit 24 receives the fluorescent image information on Cy7 from the second frame memory 23b, outputs the received fluorescent image information to a second channel of the display unit 15. In addition, the image processing circuit 24 receives image information on the reflection light obtained by the illumination light from the third frame memory 23c, and outputs the received image information to a third channel of the display unit 15.

Hereinbelow, a description will be given of the operation of the endoscope system 10′ with the above-mentioned structure according to the second embodiment.

In order to capture an image of the observation target A in the in-vivo body cavity by using the endoscope system 10′ according to the second embodiment, the fluorescent agent is pumped into the body. Further, the inserting unit 11 is inserted in the body cavity, and the end 11a thus faces the observation target A in the body cavity. In this state, the light source unit 13′ and the control unit 14 are operated. The light source 17 for illumination light and the light source 25 for excitation light are alternately operated by the operation of the light source control circuit 18, thereby generating the illumination light and the excitation light.

The excitation light and the illumination light by the light source unit 13′ are propagated to the end 11a of the inserting unit 11 via the light guide 16, and are irradiated from the end 11a of the inserting unit 11 to the observation target A.

Upon irradiating the excitation light to the observation target A, the fluorescent agent penetrated into the observation target A is excited, thereby producing fluorescent light. The excitation-light cut-off filter 26 transmits the fluorescent light produced from the observation target A, and the transmitted fluorescent light is condensed by the lenses 19a and 19b of the image pickup optical system 19 in the image pickup unit 12′, and is then incident on the variable spectroscopy device 1.

The variable spectroscopy device 1 is switched to the first state synchronously with the operation of the light source 25 for excitation light by the operation of the variable spectroscopy device control circuit 22, thereby increasing the transmittance with respect to the fluorescent agent Cy5.5 and transmitting the incident fluorescent light. In this case, the excitation light irradiated to the observation target A is partly reflected at the observation target A, and the fluorescent light and the reflected light are incident on the image pickup unit 12′. However, the image pickup unit 12′ comprises the excitation light cut-off filter 26 and the excitation light is therefore cut-off and the incident state of the excitation light on the image pickup element 20 is prevented.

Further, the fluorescent light transmitted by the variable spectroscopy device 1 is condensed by the lens 19c, and is incident on the image pickup element 20, and information on the fluorescent image is obtained. The obtained information on the fluorescent image is stored to the first frame memory 23a, the image processing circuit 24 outputs the information to the first channel of the display unit 15, and the information is displayed on the display unit 15.

Subsequently, the variable spectroscopy device 1 is switched to the second state after the passage of a predetermined time from the time for operating the light source 25 for excitation light by the operation of the variable spectroscopy device control circuit 22, thereby increasing the transmittance with respect to the fluorescent agent Cy7 and transmitting the incident fluorescent light. Further, the fluorescent light transmitted through the variable spectroscopy device 1 is incident on the image pickup element 20, and the information on the fluorescent image is obtained. The obtained information on the fluorescent image is stored to the second frame memory 23b, and the image processing circuit 24 outputs the information to the second channel of the display unit 15, and the information is displayed on the display unit 15.

On the other hand, upon irradiating the illumination light to the observation target A, the illumination light is reflected to the surface of the observation target A, is transmitted by the excitation light cut-off filter 26 and the lenses 19a and 19b in the image pickup optical system 19, and is incident on the variable spectroscopy device 1. The wavelength band of the reflection light of the irradiation light is within the fixed transmission band of the variable spectroscopy device 1. Therefore, the reflection light incident on the variable spectroscopy device 1 is totally transmitted to the variable spectroscopy device 1.

Further, the reflection light transmitted to the variable spectroscopy device 1 is condensed by the lens 19c and is incident on the image pickup element 20. Then, image information on the reflection light is obtained. The obtained image information on the reflection light is stored to the third frame memory 23c, and is output to the third channel of the display unit 15 by the image processing circuit 24. The resultant information is displayed on the display unit 15.

In this case, since the light source 25 for excitation light is turned off, the fluorescent light generated by the excitation light having a wavelength 660 nm is not generated. The wavelength band of the light source 17 for illumination light has the excitation efficiency that is extremely low with respect to the fluorescent agent and may not be substantially generated. As a consequence, only the reflection light is captured by the image pickup element 20.

As mentioned above, with the endoscope system 10′ according to the second embodiment, two fluorescent images and the reflection light image can be provided for a user.

Further, with the endoscope system 10′ according to the second embodiment, the transmission bandwidths for transmitting two fluorescent light having different wavelength bands are identical to each other and the two fluorescent images can be easily quantitatively compared and calculated.

Incidentally, according to the second embodiment, Cy5.5 and Cy7 are shown as the fluorescent agents. However, the present invention is not limited to this and another fluorescent agent can be used. Further, a plurality of fluorescent agents is excited by the excitation light having one wavelength. However, a plurality of fluorescent agents may be individually excited with a plurality of excitation light. Furthermore, in place of the combination of the images on visible reflection light and fluorescent light using a fluorescent agent, the combination of a self-fluorescent image and fluorescent light using a fluorescent agent may be used.

In addition, according to the second embodiment, the reflection films 2a and 2b are arranged to facing surfaces of the two facing optical members 3a and 3b with the air interval. In place of this, both surfaces of a single optical member may have the reflection films 2a and 2b. This corresponds to the arrangement of, not the air but optical member, at the interval between the two coating layers. In this case, the characteristics of the reflectance of the reflection films 2a and 2b may be calculated with the index of refraction of the optical member. Further, upon filling the gap between the optical members 3a and 3b with a medium such as liquid or gas except for air, the characteristics of the reflectance of the reflection films 2a and 2b may be calculated with the index of refraction of the medium.

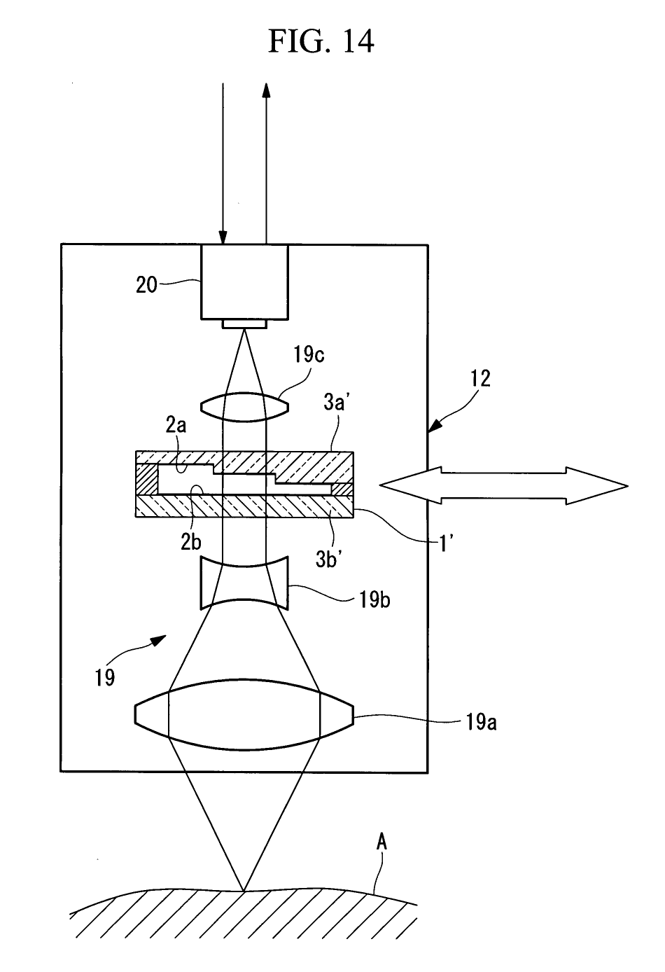

According to the first and second embodiments, with the variable spectroscopy device 1, the interval dimension between the two optical members 3a and 3b is changed by the actuator 4 comprising the piezoelectric element. However, the present invention is not limited to this. As shown in FIG. 14, at least one (e.g., optical member 3a′) of two facing optical members 3a′ and 3b′ with an interval may be stepwise formed with one or more steps in the direction along the facing surface. The reflection films 2a and 2b similar to those according to the first embodiment are placed on the facing surface. A variable spectroscopy device 1′ is arranged movably in the direction orthogonal to the optical axis.

Therefore, by moving the variable spectroscopy device 1′ in the direction orthogonal to the optical axis, the interval dimension at the light transmitting portion can be stepwise changed. As a consequence, the light transmitting band can be changed similarly to the first embodiment. According to the first embodiment, the capacitance sensor electrodes 5a and 5b are arranged for feedback control. However, in this example, a position detecting apparatus (not shown) may detect the position of the variable spectroscopy device 1′, thereby performing the feedback control.

With this structure, the interval between the facing reflection films 2a and 2b can be fixed. Therefore, as compared with the case of adjusting the interval by the control operation of the actuator 4 comprising the piezoelectric element, the transmitting band can be switched more easily, fast, and precisely.

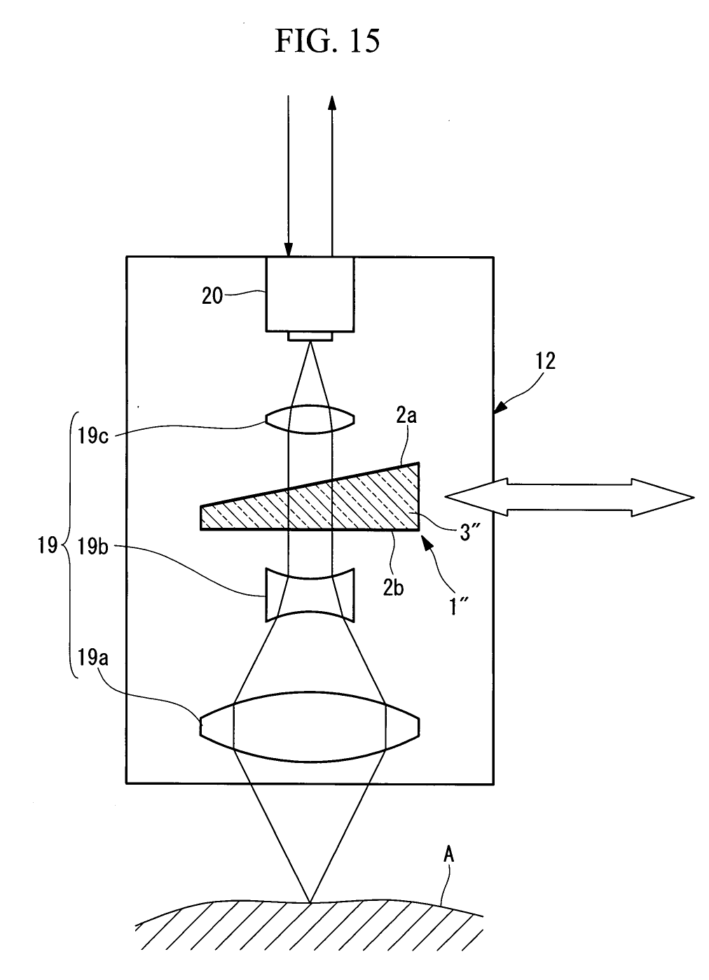

Further, in place of the variable spectroscopy device 1′ having the stepwise optical member 3a′, as shown in FIG. 15, it is possible to use a variable spectroscopy device 1″ having a wedge-shaped optical member 3″ having two non-parallel surfaces having thereon the reflection films 2a and 2b. As a consequence, similarly to the stepwise optical member 3a′, the variable spectroscopy device 1″ is moved in the direction orthogonal to the optical axis, thereby continuously changing the interval dimension between the reflection films 2a and 2b and further continuously changing the transmitting band.

In addition, in place of moving the variable spectroscopy devices 1′ and 1″ in the fixing direction orthogonal to the optical axis, the variable spectroscopy devices 1′ and 1″ may be fixed, and the light incident positions on the variable spectroscopy devices 1′ and 1″ may be changed with an arbitrary scanning unit (not shown).

What is claimed is:

1. A variable spectroscopy device that has a plurality of coating layers facing each other at an interval and changes a transmission band of light passing through the coating layers by adjusting an optical path length between the coating layers,
wherein the coating layer is structured so that a change rate of a transmission bandwidth between two arbitrary transmission bands is smaller than a change rate of a central wavelength between the two transmission bands within a spectroscopy wavelength band for changing a transmission band.

2. The variable spectroscopy device according to claim 1, wherein the transmission bandwidth is constant independently of the wavelength within the spectroscopy wavelength band.

3. The variable spectroscopy device according to claim 2, wherein the transmission bandwidth is a full width at half maximum.

4. The variable spectroscopy device according to claim 1, wherein characteristics of the coating layer are uniform within a plane.

5. The variable spectroscopy device according to claim 1, wherein the reflectance of the coating layer monotonically increases in accordance with the increase in wavelength.

6. The variable spectroscopy device according to claim 1, wherein the coating layers are arranged to facing surfaces of two optical members arranged at an interval.

7. The variable spectroscopy device according to claim 1, wherein the coating layers are arranged to facing surfaces of one optical member.

8. The variable spectroscopy device according to claim 6, wherein the optical path length between the facing surfaces changes in the directions along the facing surfaces.

9. The variable spectroscopy device according to claim 7, wherein the optical path length between the facing surfaces changes in the directions along the facing surfaces.

10. The variable spectroscopy device according to claim 8, wherein at least one of the facing surfaces is stepwise formed with one or more steps.

11. The variable spectroscopy device according to claim 9, wherein at least one of the facing surfaces is stepwise formed with one or more steps.

12. The variable spectroscopy device according to claim 8, wherein the interval between the facing surfaces gradually changes in the directions along the facing surfaces.

13. The variable spectroscopy device according to claim 9, wherein the interval between the facing surfaces gradually changes in the directions along the facing surfaces.

14. The variable spectroscopy device according to claim 1, wherein characteristics of the reflectance to the wavelength of the coating layer are expressed by the following relational expression
R(λ)=(β(λ)+2)−\sqrt{{β(λ)}²+4β(λ)}/2
β(λ)=(πm·FWHM/λ)²
where R(λ): reflectance of one etalon-type coating surface
m: degree
n: index of refraction of a medium between the etalon-type coating surfaces
FWHM: full width at half maximum as target.

15. The variable spectroscopy device according to claim 14, wherein the coating layer comprises a dielectric material.

16. The variable spectroscopy device that comprises a plurality of coating layers facing each other at an interval and optical path length adjusting means for adjusting an optical path length between the coating layers and changes a transmission band of light passing through the coating layer by adjusting the optical path length by the optical path length adjusting means,
wherein the coating layer is structured so that a change rate of a transmission bandwidth between two arbitrary transmission bands is smaller than a change rate of a central wavelength between the two transmission bands within a spectroscopy wavelength band for changing a transmission band.

17. A spectroscopy apparatus comprising the variable spectroscopy device according to claim 1.

18. The spectroscopy apparatus according to claim 17, further comprising a two-dimensional image pickup device that shoots light passing through the variable spectroscopy device.

19. The spectroscopy apparatus according to claim 18, wherein an observation target is a living body.

20. The spectroscopy apparatus according to claim 19, wherein the observation target is a part of the body cavity.

21. The spectroscopy apparatus according to claim 17, wherein the interval between the coating layers of the variable spectroscopy device corresponds to an interval having only one transmission band within the spectroscopy wavelength band.

22. A spectroscopy endoscope system comprising the variable spectroscopy device according to claim 1.

23. A spectroscopy endoscope system comprising the variable spectroscopy device according to claim 16.
